(19) United States
(12) Patent Application Publication
(10) Pub. No.: US 2014/0363007 A1
(43) Pub. Date: Dec. 11, 2014

(54) WEARABLE DEVICE FOR RELIEVING TINNITUS, HYPERACUSIS AND/OR HEARING LOSS

(71) Applicant: Sanuthera, Inc., Athens, OH (US)

(72) Inventors: Jeffrey D. DiGiovanni, Athens, OH (US); Stephen Rizzo, Kingston, OH (US)

(21) Appl. No.: 14/465,522

(22) Filed: Aug. 21, 2014

Related U.S. Application Data
(63) Continuation-in-part of application No. 13/670,003, filed on Nov. 6, 2012.
Application No. 13/670,003 is a continuation of application No. 11/599,719, filed on Nov. 14, 2006, now Pat. No. 8,306,248.
(60) Provisional application No. 60/836,294, filed on Aug. 8, 2006.
(60) Provisional application No. 60/812,484, filed on Jun. 9, 2006.
(60) Provisional application No. 60/736,513, filed on Nov. 14, 2005.

(51) Int. Cl. H04R 25/00

(52) U.S. Cl. CPC H04R 25/75
USPC 381/60

(57) ABSTRACT

A wearable device and computerized system and method for configuring a wearable device for use in the treatment of tinnitus, hyperacusis, and/or hearing loss is disclosed. A software application for use by an audiologist facilitates the diagnosis and assessment of a patient's needs and programming of the wearable device with customized settings and/or audio signals specific to the patient's needs. The customized settings and audio signals may form a part of a tinnitus retraining therapy treatment regime for a patient. The wearable device may further comprise customized settings and sounds for treating hyperacusis and/or hearing loss in a patient. The customized settings can be modified by the audiologist during the fitting process to ensure the patient is fitted with a device that provides appropriate relief for the patient's specific needs.

### RELATED APPLICATIONS

This application is a continuation-in-part of U.S. patent application Ser. No. 13/670,003 filed Nov. 6, 2012, titled APPARATUS, SYSTEMS AND METHODS FOR RELIEVING TINNITUS, HYPERACUSIS AND/OR HEARING LOSS, which is a continuation of U.S. patent application Ser. No. 11/599,719 filed Nov. 14, 2006, titled APPARATUS, SYSTEMS AND METHODS FOR RELIEVING TINNITUS, HYPERACUSIS AND/OR HEARING LOSS, now U.S. Pat. No. 8,306,248, issued Nov. 6, 2012, which in turn claims priority to U.S. Provisional Patent Application Ser. No. 60/836,294, filed on Aug. 8, 2006, U.S. Provisional Patent Application Ser. No. 60/812,484, filed on Jun. 9, 2006, and U.S. Provisional Patent Application Ser. No. 60/736,513, filed on Nov. 14, 2005, the contents of which are incorporated herein by reference.

### FIELD OF THE INVENTION

The present invention generally relates to medical apparatus, systems, and methods. The present invention more particularly relates to medical apparatus, systems, and methods advantageous for relieving hearing related conditions, including tinnitus, hyperacusis, and/or hearing loss.

### BACKGROUND

Tinnitus is the sensation of a sound in the ear or head that is not being produced by an external source. Approximately 14 million hearing and hearing-impaired individuals in the United States suffer from some form of significant tinnitus for which medical treatment was sought. More than two-million Americans are debilitated with tinnitus to the point where it affects their daily functions, including job performance, and personal relationships. Furthermore, the prevalence of tinnitus increases with age, and the demand for tinnitus treatment will significantly increase over the next thirty years.

Hyperacusis, on the other hand, may be defined as a reduced tolerance to normal environmental sounds. Hyperacusis sufferers range from someone mildly uncomfortable in a normal social setting to someone profoundly discomforted by many of the sounds encountered in daily life. Individuals with initially reduced loudness discomfort levels (LDLs) generally exhibit a reduced dynamic range, which is the intensity range over which we hear sound, from the softest sound perceptible to the loudest sound tolerable. The reduced dynamic range usually manifests in a reduced tolerance to more intense sounds, even those that would be considered moderately soft to normal listeners.

Many individuals who suffer from tinnitus and/or hyperacusis may also suffer from some form of hearing loss. Such individuals often benefit from the use of wearable ear-level devices that provide audio signals to treat and/or relieve the symptoms of tinnitus, hyperacusis, and/or hearing loss. Such individuals receive the greatest benefit from audio signals that are adapted for their specific needs. It would be advantageous to have a new system and method for diagnosing and assessing a patient's needs and for fitting a wearable ear-level device with customized audio signals to treat and/or relieve the symptoms of tinnitus, hyperacusis, and/or hearing loss.

### SUMMARY

The present disclosure is directed to a wearable device and configuration of a wearable device for relieving tinnitus, hyperacusis, and/or hearing loss. Following diagnosis and assessment of a patient's specific needs, the wearable device is fitted with customized settings and/or audio signals to provide relief to the patient. The wearable device may comprise different form factors and different component parts. A software application for use by an audiologist facilitates the diagnosis and assessment of a patient's needs and programming of the wearable device with customized settings and/or audio signals specific to the patient's needs. The customized settings and audio signals may form a part of a tinnitus retraining therapy treatment regime for a patient. The wearable device may further comprise customized settings and sounds for treating hyperacusis and/or hearing loss in a patient.

The disclosed device, system, and method comprise integrated diagnostic and psychoacoustic assessment protocols and customized fitting features for a wearable device. The wearable device and related software application obviate the need for dedicated hardware in the clinical setting while improving the efficiency of the fitting process. The wearable device can be programmed with customized settings and/or audio signals based on the results of the integrated diagnostics and assessment protocols. The customized settings can be modified by the audiologist during the fitting process to ensure the patient is fitted with a device that provides appropriate relief for the patient's specific needs. In an example embodiment, the wearable device connects to an intermediary device adapted for wireless communication with a patient's ear-level devices.

### BRIEF DESCRIPTION OF THE DRAWINGS

These and other features, aspects, and advantages of the present invention are better understood when the following Detailed Description is read with reference to the accompanying drawings, which constitute part of this specification.

FIG. 1 depicts a wearable device according to an example embodiment of the invention.

FIG. 2 is a launch screen for a fitting software application according to an example embodiment of the invention.

FIG. 3 is a sound selection details screen according to an example embodiment of the invention.

FIG. 4 is a pitch matching (PM) protocol details screen according to an example embodiment of the invention.

FIG. 5 is a band-pass filter details screen according to an example embodiment of the invention.

FIG. 6 is a minimum masking level (MML) details screen according to an example embodiment.

### DETAILED DESCRIPTION

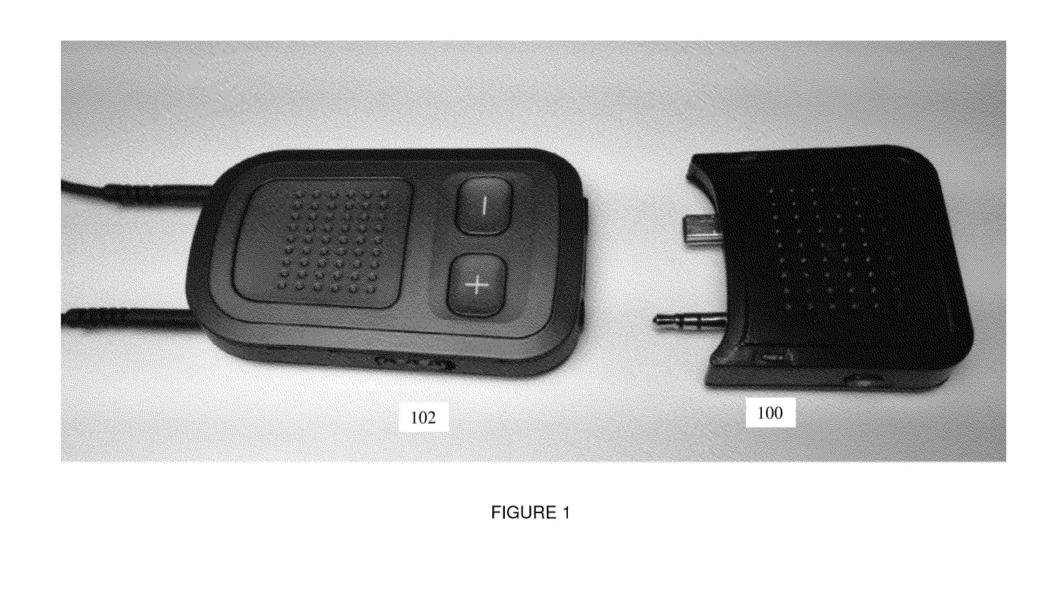

A wearable device is customized with settings and/or audio signals to provide a patient with relief from tinnitus, hyperacusis, and/or hearing loss. A fitting software application for use by an audiologist assists the audiologist in completing diagnostic and psychoacoustic assessment protocols and in customizing fitting features for the wearable device. Referring to FIG. 1, a wearable device according to an example embodiment is shown. In an example embodiment, a patient's customized settings and/or sounds are transmitted to a programmable wearable device that connects wirelessly with a patient's ear-level devices and that connects to an intermediary device for transmitting sounds from the wearable device to a user's ear-level devices. In the example embodiment, the wearable device is a Silicon Labs® CP2210 100 and the intermediary device is a Unitron® uDirect2™ 102. One of skill in the art would recognize the claimed functionality may be incorporated into a single, wearable device of various shapes and sizes or incorporated into several cooperating devices.

In an example embodiment, a patient's ear-level devices are programmed using fitting software for the intermediary device. Once programmed according to the patient's audiogram, the intermediary device, which may be worn around the neck, transmits sounds to the patient's ear-level devices such as audio signals received from other devices (e.g., mobile phones, MP3 players, and the wearable device).

A fitting software application is used to customize the wearable device for each ear independently or both ears together. The software application may execute on a computerized device such as a laptop computer or tablet computer. In an example embodiment, the wearable device is connected to the computerized device with a USB cable to facilitate communication between the fitting application and the wearable device. The wearable device may be initialized with a driver and other device software needed for communication with the fitting application and to further provide audio signals to the intermediary device.

In another embodiment, the wearable device is connected to the computerized device wirelessly via a plurality of wireless protocols.

In an embodiment, the fitting process begins with the patient or audiologist inserting the hearing aids paired with the intermediary device, the intermediary device and wearable device are connected and powered on, the wearable device is connected to a computer (e.g., using a USB cable) and the fitting software application is started. Patient assessments are controlled through the fitting software application and stimuli is presented through the wearable device.

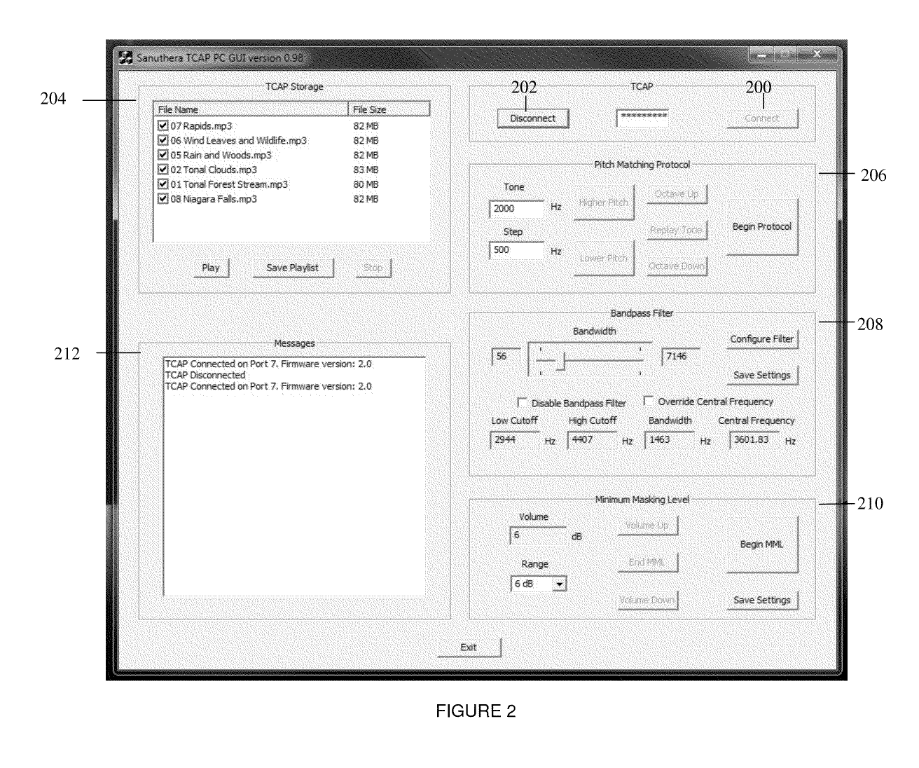

Referring to FIG. 2, a launch screen for a fitting software application according to an example embodiment is shown. The selection of the “Connect” option 200 establishes communication between the fitting software application and the wearable device. When the fitting process is completed, the “Disconnect” option 202 discontinues the communication between the fitting software application and the wearable device. The launch screen further comprises a sound selection section 204, a messages section for communicating status information and other messages to the user 212, and a plurality of diagnostics sections 206 208 210. In an example embodiment, the diagnostics include any of the following in any combination:

TABLE 1
Example Diagnostics

| Parameter | Description |
|---|---|
| Pitch Matching (PM) | This paradigm allows the patient to match the pitch, primary pitch, or |
| 206 | predominant pitch of his/her tinnitus to a pure-tone generated and/or stored |
| | by the device. |
| Bandwidth Matching | In situations where the tinnitus is not tonal per se, it is of use to know the |
| (BM) | range of frequencies the tinnitus spans. Therefore, the BM allows an |
| 208 | estimate, of this which can inform the range of frequencies that should |
| | minimally be included in the therapy sound. One manner of implementing |
| | this is by setting band-pass filter cutoff frequencies to span a range of |
| | frequencies equal to or greater than the range of the tinnitus as measured by |
| | the BM. |
| Minimum Masking Level | Tinnitus sounds do not follow traditional energetic masking patterns. |
| (MML) | Therefore, the level of sound necessary to mask tinnitus is not predictable. |
| 210 | Moreover, using the preferred sounds as chosen by the patient may impact |
| | the MML. It is also important for certain types of tinnitus therapy (e.g., |
| | tinnitus retraining therapy) to ensure that the therapy sounds are set such |
| | that they never mask the tinnitus completely which requires the MML. |
| Loudness Matching | This paradigm allows a match to be made between the intensity of an |
| (LM) | externally-generated sound (i.e., generated by the wearable device) and the |
| | loudness of the patient's tinnitus. |
| Tinnitus-Type Matching | Tinnitus can take the sound of several forms, including that of a pure tone or |
| (TTM) | pure-tone complex, buzzing, humming, whooshing, narrow-band noises etc. |
| | This paradigm allows the patient to identify the “sound percept” of his/her |
| | tinnitus allowing selection of stored sounds to be made more effectively. |

There are numerous methods to measure any of the above acoustic parameters. For PM, LM, MML, and BM measurements, a simple adaptive, up-down procedure may be used. The simplest is a 1-up/1-down. In the PM, for example, the patient is presented with a 1.0 kHz pure tone. The patient indicates whether his/her tinnitus is of a higher pitch than the presented tone. With this response, a subsequent tone is presented based on the previous tone, the patient's response, and a preset factor or fixed change (e.g., 1.5× or 500 Hz). If the former, then starting a 1.0 kHz, patient responding “higher”, and a 1.5× factor, the subsequent tone would be 1.5 kHz. If then, the patient responds “lower” the next frequency would be 1.5 kHz divided by 1.5, or 1.0 kHz. The frequency at which the pattern of responses goes from “higher” to “lower” or vice versa is called a turnaround. In an embodiment, the PM is determined by averaging the final six of a total of eight turnarounds. Also in an embodiment, the step size may decrease after the first two turnaround from, for example, 1.5× to 1.25×.

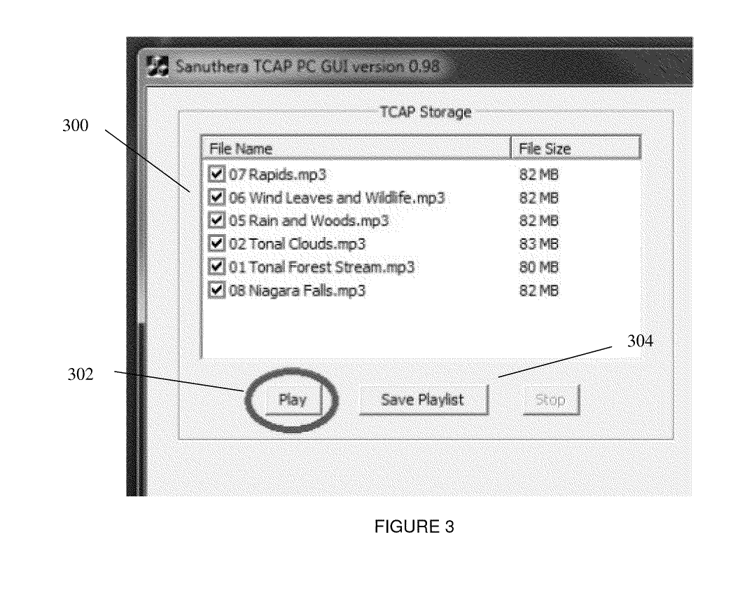

Referring to FIG. 3, a sound selection details screen according to an example embodiment is shown. The audiologist selects each track on the survey 300 using the “Play” option 302 and allows the patient to listen for period of time such as 90 seconds. For each track, the patient completes a sound selection survey such as the survey shown below.

TABLE 1
Sound Selection Survey

| | 1 | 2 | 3 | 4 | 5 |
|---|---|---|---|---|---|
| I find this track to be pleasing. | | | | | |
| Listening to this track draws my attention away | | | | | |
| from my tinnitus. | | | | | |
| I would much rather listen to this track than my | | | | | |
| tinnitus. | | | | | |
| I could listen to this track for several hours. | | | | | |

1—Completely Agree
2—Somewhat Agre
3—Neither Agree nor Disagree
4—Somewhat Disagree
5—Completely Disagree

The patient's preferred selections are saved to a playlist by selecting a “Save Playlist” option 304. In an example embodiment, all of the sound tracks are stored on the wearable device but only the tracks selected by the patient are added to the playlist for playback on the device. The audiologist then completes one or more diagnostic tests depending on the patient's needs.

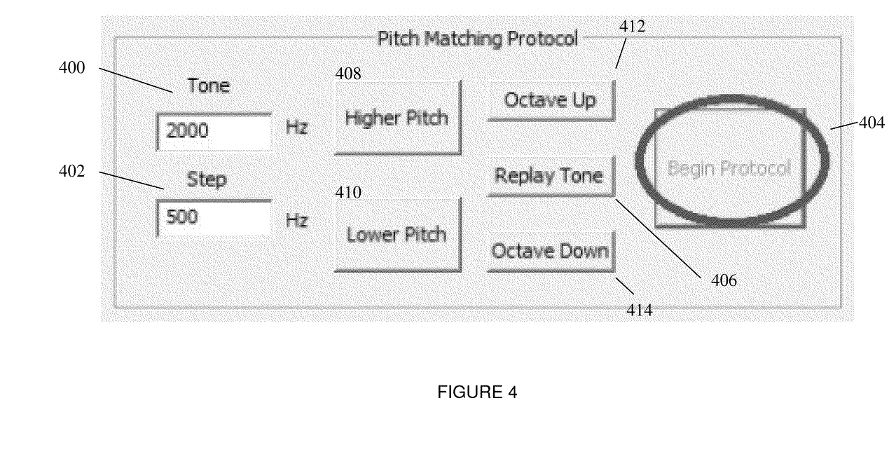

Referring to FIG. 4, a pitch matching protocol details screen according to an example embodiment is shown. The audiologist determines the approximate frequency for pitch matching based on the subject's description of the tinnitus, or simply begins at an arbitrary frequency (e.g., 1.0 kHz) and then adjusts the frequency as needed based on the patient's responses. The audiologist enters the starting frequency under the Tone field 400 and beginning step size under the “Step field” 402 and selects the “Begin Protocol” option 404 to start pitch matching. The audiologist may select the “Replay Tone” option to allow a second exposure to the same frequency 406 and asks the patient if his/her tinnitus is “higher” or “lower” than the tone presented. The pitch may be increased or decreased with the “Higher Pitch” option 408 or “Lower Pitch” option 410 based on patient's response. Once the patient matches the pitch to the played tone, the “Octave Up” option 412 and “Octave Down” option 414 may be selected along with replaying the tone to ensure there is no octave confusion. After a few reversals (aka turnarounds), the fitting application calculates and displays the tinnitus frequency in the FIG. 1 messages section 212. After the pitch matching protocol is complete, the fitting application also automatically updates the band-pass filter settings.

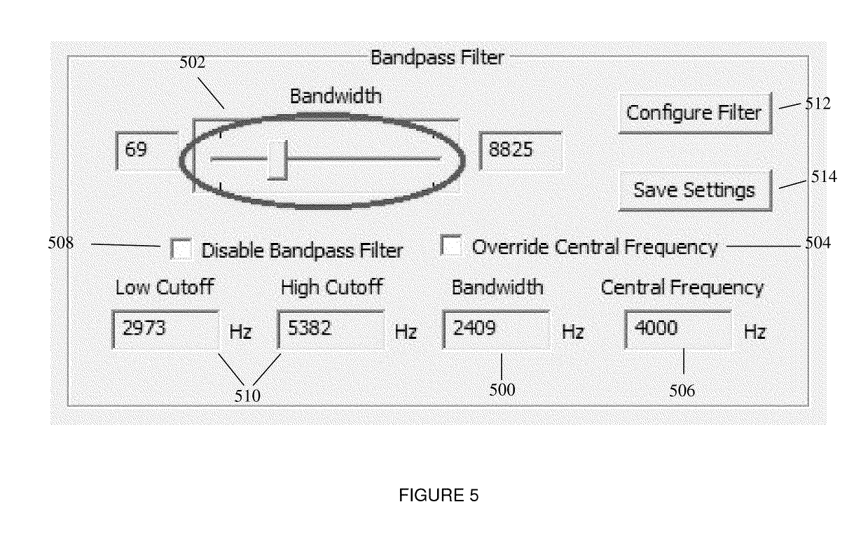

Referring to FIG. 5, a band-pass filter details screen according to an example embodiment is shown. These filter parameters may be changed depending on the patient's preferences. The bandwidth of the filter 500 may be adjusted by moving a slider 502. The center of the frequency may be manually entered by selecting an “Override Central Frequency” option 504 and entering a “Central Frequency” value 506. Additionally, the band-pass filter may be disabled by selecting a “disable band-pass filter” option 508. The Low and High Cutoff frequencies 510 may be ⅓ octave above and below. This parameter may be set as part of the design of the device or adjusted by the audiologist. To save the changes, the audiologist selects the “Configure Filter” 512 and “Save Settings” options 514.

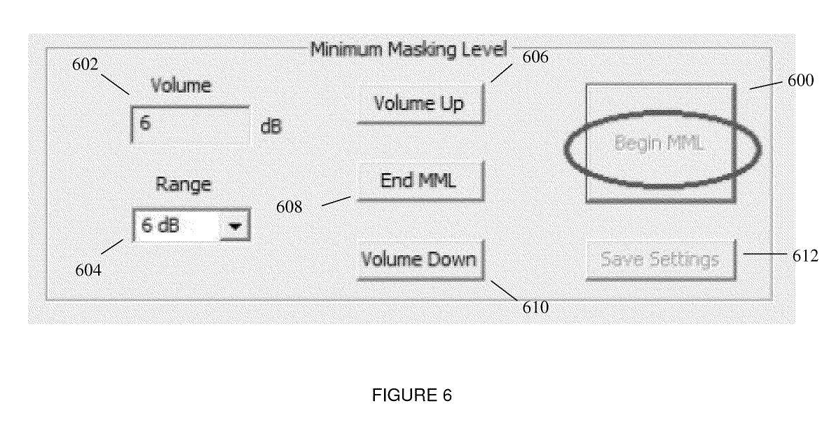

Referring to FIG. 6, a minimum masking level details screen according to an example embodiment is shown. Once the band-pass filter is set (as described in FIG. 5), the audiologist initiates the MML test. The MML is used to set the maximum output or volume level to ensure the therapy sound never completely masks the tinnitus (e.g., maximum volume is the MML−1 dB). Initially, the audiologist selects a sound file for masking the tinnitus (as described in FIG. 3). After selecting the sound file, the audiologist selects the “Begin MML” option 600, sets the volume value 602, and selects a volume range 604. After instructing the patient to indicate when he/she no longer hears the tinnitus, the audiologist Increases or decreases the volume by selecting “Volume Up” option 606 or “Volume Down” option 610 to determine the minimum level that masks the tinnitus. Once the MML is determined, the procedure automatically ends. Alternatively, the audiologist can end the procedure by selecting the “End MML” option 608 The audiologist selects the “Save Settings” option 612 to store the data on the wearable device.

The audiologist completes the fitting protocol which may include any number of the above assessments shown in Table 1 and/or described in FIGS. 4-6. As the assessments are completed, the fitting software application determines “first fit” settings for the device. After consulting with the patient, the audiologist may adjust the settings to improve comfort, pleasantness, or other aspects as he/she sees fit. For example, a library of therapy sounds (i.e., playlist of preferred sounds) and a band-pass filter may be included in the wearable device. Alternatively, the band-pass filter may be by-passed.

In an example embodiment, the initial sound library is preloaded on the wearable device. Sounds may be deleted and/or uploaded by the practitioner or, alternatively, by the patient with provided software. Settings generated during the fit, include but are not limited to the (1) sounds that remain active (i.e., preferred playlist); (2) pitch match; (3) filter coefficients or filter defeat; and (4) volume settings. The settings are stored internal to the wearable device upon completion of the fit. During use of the wearable device, selected sounds are played according to the patient's customized settings and/or selections. When a device is reconnected to the fitting software, these settings are automatically retrieved and displayed in the fitting software. Parameter changes and other settings after subsequent fits may be maintained by the fitting application along with earlier settings, thus creating a historical database of all settings and changes over time.

In an example embodiment, the wearable device contains various interfaces (e.g., buttons) to ensure full user control. For example, the user has the ability to change volume, up or down, in steps set in the fitting software by the audiologist. The user also has the ability to increment forward or backward the track being played. The user may also play and/or stop the audio playback. The wearable device software application plays the sounds according to the patient's customized settings. Finally, there is a power-on and power-off selection. The sounds are transmitted through the intermediary device which wirelessly transmits sounds to the ear-level devices. The ear-level devices receive the sounds selected by the user and otherwise function as hearing aids.

In another embodiment, the fitting software may be contained on the wearable device. The wearable device functions as having the stored sounds, the assessments, and patient interface for cant oiling the device and the playback of stored sounds (e.g., power buttons, play/stop, volume controls, track forward/backward) as well as a screen to allow the audiologist to perform the assessments through fitting software installed on the wearable device. An example is a smart phone in which both the fitting application as well as the treatment and patient-interface functions are installed. In this embodiment, the wearable device communicates wirelessly with the ear-level devices without the need for an intermediary device. As in the previous embodiments, the protocols may be performed for each ear independently, or both ears together.

In another embodiment, all the functions of the wearable device are contained in the ear-level devices obviating the need for a wearable device. In this embodiment, the fitting software, based on a computer, laptop, tablet, or smart phone, etc., communicates wirelessly or via physical connection directly to the ear-level devices in the manner described for the previous embodiment. The sounds and customized parameters are stored on the ear-level devices. Additionally, the ear-level devices comprise user controls for playing sounds, etc. The ea level devices further function as hearing aids. In another similar embodiment, the fitting software communicates with one of the ear-level devices which serves as the “master” device that further controls the other ear-level device serving as a “slave” device.

The foregoing description of embodiments of the present invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

1. A method for communicating sound to ear-level devices to relieve hearing disorders comprising:
(a) storing on a wearable device:
(i) a device application for said wearable device; and
(ii) a plurality of selectable sounds;
(b) receiving at a computer executing a fitting application for said wearable device at least one customized setting resulting from a diagnostic assessment of a patient;
(c) transferring said customized setting from said computer to said wearable device; and
(d) in response to detecting by said device application a selection of one of said selectable sounds on said wearable device, applying/applies said customized setting to a transmission of said selected sound from said wearable device to said ear-level devices.

2. The method of claim 1 wherein said transmission of said selected sound from said wearable device to said ear-level devices comprises transmitting said selected sound through an intermediary device in communication with said ear-level devices.

3. The method of claim 2 wherein said wearable device connects physically to said intermediary device.

4. The method of claim 1 wherein said at least one customized setting is selected from the group consisting of:
a pitch matching parameter; a minimum masking level parameter; a loudness matching parameter; and a tinnitus type matching parameter.

5. The method of claim 1 wherein said at least one customized setting is selected from the group consisting of:
an active setting for each of said plurality of selectable sounds; a filter coefficient; and a volume setting.

6. The method of claim 1 further comprising:
(a) updating said at least one customized setting;
(b) transferring said updated customized setting to said wearable device; and
(c) storing on said wearable device said at least one customized setting and said updated customized setting.

7. The method of claim 1 wherein receiving at said computer at least one customized setting comprises receiving at said computer at least one modified customized setting.

8. The method of claim 1 wherein said wearable device comprises hearing aid functionality.

9. A method for communicating sound to ear-level devices to relieve hearing disorders comprising:
(a) storing on a wearable device:
(i) a device application for said wearable device; and
(ii) a plurality of selectable sounds;
(b) receiving at a computer executing a fitting application for said wearable device:
(i) a playlist for selecting at least two of said plurality of selectable sounds; and
(ii) at least one customized setting resulting from a diagnostic assessment of a patient;
(c) transferring said playlist and said customized setting from said computer to said wearable device; and
(d) in response to detecting by said device application a selection from said playlist on said wearable device, applying/applies said customized setting to a transmission of said selection from said wearable device to said ear-level devices.

10. The method of claim 9 wherein said transmission of said selected sound from said wearable device to said ear-level devices comprises a transmission of said selected sound through an intermediary device in communication with said ear-level devices.

11. The method of claim 10 wherein said wearable device connects physically to said intermediary device.

12. The method of claim 9 wherein said at least one customized setting is selected from the group consisting of:
a pitch matching parameter; a minimum masking level parameter; a loudness matching parameter; a bandwidth matching parameter; and a tinnitus type matching parameter.

13. The method of claim 9 wherein said at least one customized setting is selected from the group consisting of:
an active setting for each of said plurality of selectable sounds; a filter coefficient; and a volume setting.

14. The method of claim 9 further comprising:
(a) updating said at least one customized setting;
(b) transferring said updated customized setting to said wearable device;
(c) storing on said wearable device said at least one customized setting and said updated customized setting; and
(d) storing in the fitting-software database the customized settings.

15. The method of claim 9 wherein receiving at said computer at least one customized setting comprises receiving at said computer at least one modified customized setting.

16. The method of claim 9 wherein said wearable device comprises hearing aid functionality.

17. A system for communicating with ear-level devices to relieve hearing disorders comprising:
(a) a wearable device storing:
(i) a device application for said wearable device; and
(ii) a plurality of selectable sounds;
(b) a computer processor executing a fitting application for said wearable device with instructions to:
(i) receive at least one customized setting resulting from a diagnostic assessment of a patient; and
(ii) store said customized setting on said wearable device; and
(c) wherein in response to detecting by said device application a selection of one of said selectable sounds on said wearable device, said device application applying/applies said customized setting to a playback of said selected sound for said ear-level devices.

18. The system of claim 17 wherein said playback of said selected sound for said ear-level devices comprises a transmission of said selected sound through an intermediary device in communication with said ear-level devices.

19. The system of claim 18 wherein said wearable device connects physically to said intermediary device.

20. The system of claim 17 wherein said at least one customized setting is selected from the group consisting of:
a pitch matching parameter; a minimum masking level parameter; a loudness matching parameter; bandwidth matching; and a tinnitus type matching parameter.

21. The system of claim 17 wherein said at least one customized setting is selected from the group consisting of:
an active setting for each of said plurality of selectable sounds; a filter coefficient; and a volume setting.

22. The system of claim 17 wherein said instruction to receive at said computer processor at least one customized setting comprises an instruction to receive at said computer processor at least one modified customized setting.

23. The system of claim 17 wherein said wearable device comprises hearing aid functionality.

24. A system for relieving hearing disorders comprising:
(a) an ear-level device storing:
(1) a plurality of selectable sounds; and
(2) a control application for said ear-level device to:
(i) receive at least one customized setting resulting from a diagnostic assessment of a patient;
(ii) store said customized setting on said ear-level device; and
(iii) play a selected sound using said customized setting; and
(b) a computer processor in communication with said ear-level device executing a fitting application to:
(1) determine said at least one customized setting based on said diagnostic assessment; and
(2) transmit said customized setting to said ear-level device.

25. The system of claim 24 wherein said ear-level device is a master ear-level device that controls a slave ear-level device.
